(19) United States
(12) Patent Application Publication
(10) Pub. No.: US 2012/0028532 A1
(43) Pub. Date: Feb. 2, 2012

(54) STUFFED TOYS HAVING INTERCHANGEABLE SCENT PACKETS AND METHODS AND SYSTEMS INCLUDING SUCH STUFFED TOYS

(75) Inventors: Heidi Thompson, Eagle, ID (US); R. Orville Thompson, Eagle, ID (US)

(73) Assignee: SCENTSY, INC., Meridian, ID (US)

(21) Appl. No.: 13/191,362

(22) Filed: Jul. 26, 2011

Related U.S. Application Data
(60) Provisional application No. 61/368,177, filed on Jul. 27, 2010.

(51) Int. Cl. A63H 3/00; B23P 17/04

(52) U.S. Cl. 446/73; 29/428

(57) ABSTRACT

A scented stuffed toy including at least one interchangeable scented packet, a method of forming the scented stuffed toy, and a system for scenting an area. The scented stuffed toy includes an interior portion within a body of the stuffed toy, at least one interchangeable scented packet disposed within the interior portion, and a fastening structure for selectively accessing the interior portion. The scented stuffed toy may be formed by opening a fastening structure in a body of the stuffed toy to expose an interior portion of the body of the stuffed toy, disposing at least one interchangeable scented packet within the interior portion of the body of the stuffed toy, and closing the fastening structure. A system for scenting an area including the scented stuffed toy is also disclosed.

### CROSS-REFERENCE TO RELATED APPLICATION

This application claims the benefit of U.S. Provisional Patent Application Ser. No. 61/368,177, filed Jul. 27, 2010, entitled “Stuffed Toys having Interchangeable Scent Packets and Methods and Systems including such Stuffed Toys,” the disclosure of which is incorporated herein by reference in its entirety.

### TECHNICAL FIELD

Embodiments of the present disclosure relate generally to stuffed toys including interchangeable scent packets and methods and systems including such stuffed toys.

### BACKGROUND

It is commonly known to provide scented materials for certain items or areas to enhance one's olfactory perception of that item or area. For example, it is common practice to place potpourri, candles, or other scented materials in areas that do not typically have an appealing odor, such as inside a vehicle, a gym bag, a bathroom, or the like. However, these scented materials do not release scent perpetually and therefore must be disposed of or replaced once spent. In addition, most scented materials are primarily functional in appearance, and therefore offer little or no aesthetic or entertainment value.

### BRIEF SUMMARY

In some embodiments, the present disclosure includes a stuffed toy. The stuffed toy comprises an interior portion within a body of the stuffed toy, at least one interchangeable scented packet disposed within the interior portion, and a fastening structure for providing selective access to the interior portion.

Additional embodiments of the present disclosure include a system for scenting an area. The system comprises, a stuffed toy comprising an interior portion within a body of the stuffed toy and at least one interchangeable scented packet configured to be removably disposed within the interior portion.

In additional embodiments, the present invention includes methods of forming a scented stuffed toy. The methods include opening a fastening structure in a body of a stuffed toy to access an interior portion of the body of the stuffed toy, disposing at least one interchangeable scented packet within the interior portion of the body of the stuffed toy, and closing the fastening structure.

### BRIEF DESCRIPTION OF THE SEVERAL VIEWS OF THE DRAWINGS

While the specification concludes with claims particularly pointing out and distinctly claiming what are regarded as embodiments of the present invention, various features and advantages of embodiments of the disclosure may be more readily ascertained from the following description of example embodiments of the disclosure when read in conjunction with the accompanying drawings, in which:

FIG. 1 illustrates a front view of a stuffed toy configured to contain at least one interchangeable scented packet therein;

FIG. 2 illustrates a back view of the stuffed toy of FIG. 1 configured to contain at least one interchangeable scented packet therein;

FIG. 3 illustrates a side view of the stuffed toy of FIG. 1 configured to contain at least one interchangeable scented packet therein;

FIG. 4 illustrates the stuffed toy of FIG. 2 opened to expose an interior portion of the stuffed toy;

FIG. 5 illustrates an enlarged view of an interchangeable scented packet for use in the stuffed toy;

FIG. 6 illustrates the stuffed toy of FIG. 4 having the at least one interchangeable scented packet disposed in the interior portion of the stuffed toy; and

FIG. 7 illustrates another embodiment of a stuffed toy configured to contain more than one interchangeable scented packet in the interior portion of the stuffed toy.

### DETAILED DESCRIPTION

The stuffed toy of embodiments of the present disclosure includes at least one interchangeable scented packet therein. The stuffed toy may be in the form of a stuffed animal, or it may have another form, such as a stuffed doll-like figure, or an inanimate object such as a house, a vehicle, a plant, and so on. Thus, the present disclosure is not limited to typical stuffed toys, such as stuffed animals. Additionally, while embodiments of the present disclosure are referred to as a stuffed toy, some embodiments of the present disclosure may not be suitable or intended for children and, accordingly, the term “toy” is used in an inclusive, rather than an exclusive, sense. In other words, the term “toy” means and encompasses ornamental, stuffed objects in a broad sense. The term “stuffed” means and includes a fabric or other flexible structure (for example, a synthetic fur) enclosing a soft stuffing material, as is conventionally employed with stuffed animals and other toys.

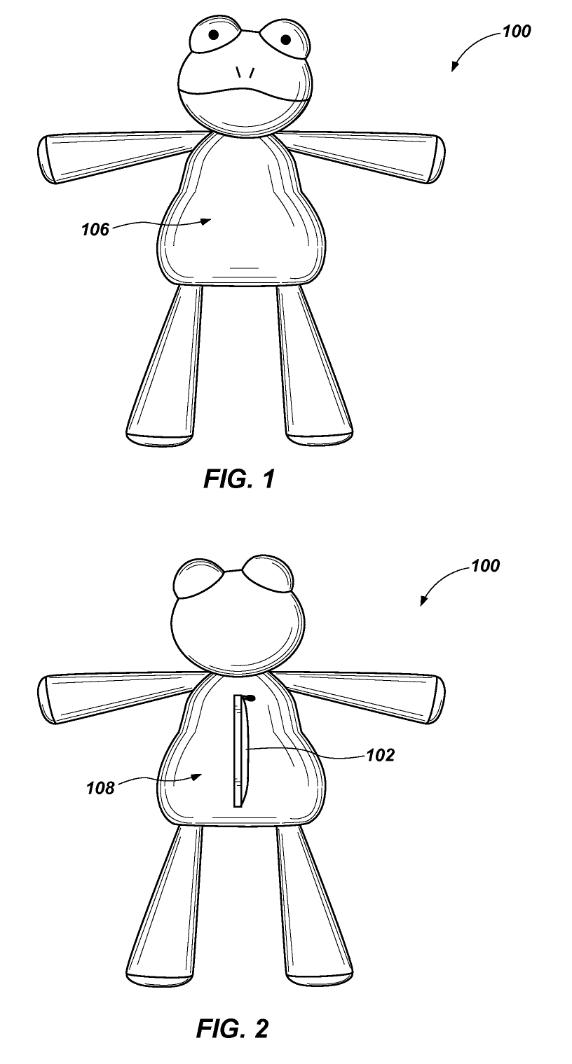

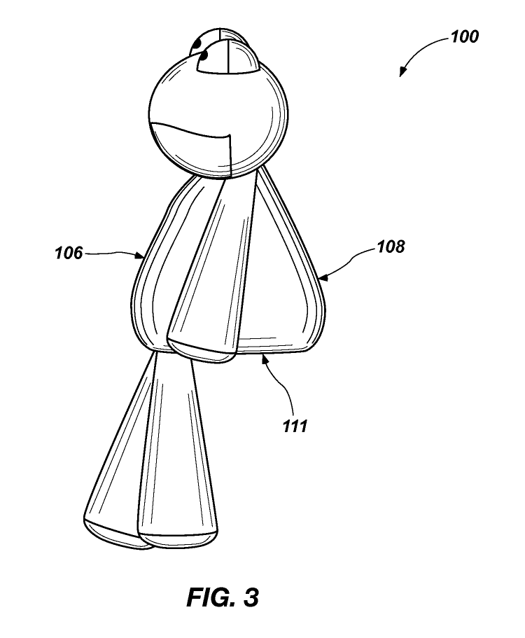

Referring now to the drawings, FIGS. 1-3 are schematic illustrations of a stuffed toy 100 in the form of a frog configured to contain at least one interchangeable scented packet therein. Other non-limiting example forms of the stuffed toy 100 include a bear, a lion, an elephant, a monkey, a pig, a lamb, a fish, a snake, and an octopus, as well those examples mentioned previously herein. FIG. 1 illustrates a front portion 106 of the stuffed toy 100, FIG. 2 illustrates a back portion 108 of the stuffed toy 100, and FIG. 3 illustrates a side portion of the stuffed toy 100. In some embodiments, the stuffed toy 100 may be sized to fit within a small area, such as, a bag or a drawer. In additional embodiments, the stuffed toy 100 may be of a larger size so as to be displayed or played with. As shown in FIG. 1, the front portion 106 generally includes a face or other primary features of the stuffed toy 100.

As shown in FIG. 3, in some embodiments, the stuffed toy 100 may include an at least substantially horizontal surface 111 extending from the front portion 106 to the back portion 108 of the stuffed toy 100. The at least substantially horizontal surface 111 may allow the stuffed toy 100 to sit in a stable manner on a complementary horizontal surface, such as, for example, a shelf, a desk, or a counter.

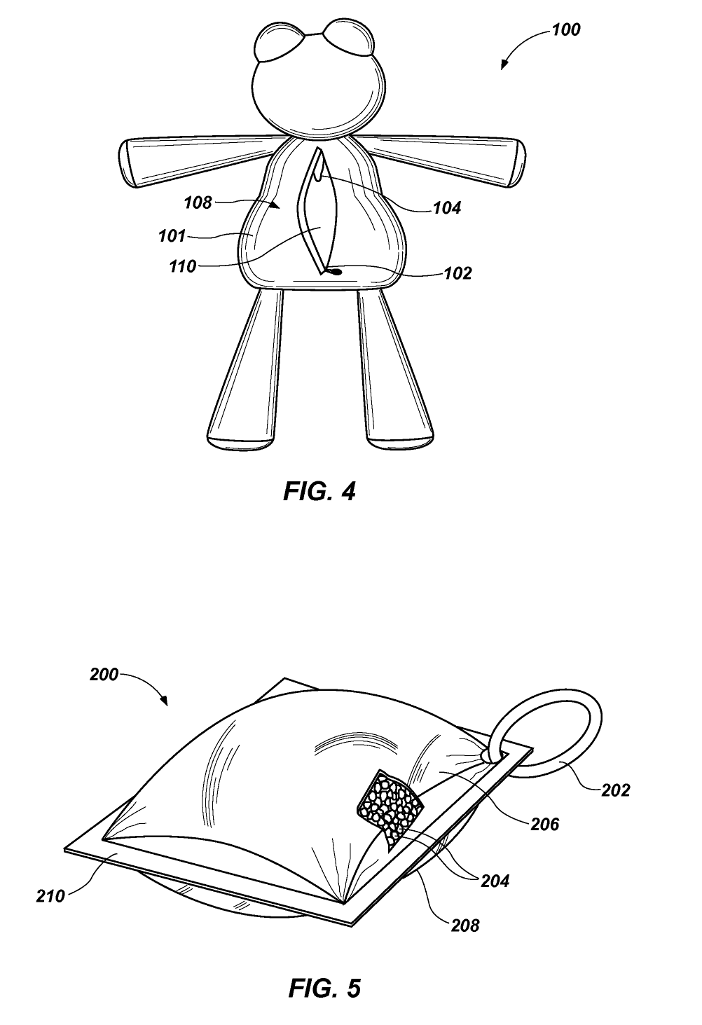

As shown in FIG. 4, the back portion 108 of the stuffed toy 100 generally includes a back surface of the stuffed toy 100. The back portion 108 of the stuffed toy 100 includes a fastening structure 102 along an exterior of a body 101 of the stuffed toy 100. The fastening structure 102 may comprise, for example, a zipper (as illustrated in FIG. 2), buttons, a hook-and-loop fastener (e.g., VELCRO®), or a magnetic fastener. The fastening structure 102 acts to hold together portions of the stuffed toy 100, which when separated provide an aperture to at least one chamber of the interior portion 110 of the stuffed toy 100. The fastening structure 102 may be used to conceal and close off an interior portion 110 of the stuffed toy 100 to provide a closed chamber concealed within the interior portion 110 of the stuffed toy 100. The fastening structure 102 also provides easy, tool-free access to the interior portion 110 of the stuffed toy 100. In some embodiments, the stuffed toy 100 may be made of a porous or breathable material to facilitate the movement of air therethrough between the interior portion 110 and an exterior portion of the body 101. It should be noted that the interior portion 110 may be located within any portion of the body 101, and an aperture for accessing the interior portion 110 may likewise be provided, along with an associated fastening structure 102, on any exterior portion the body 101 or on a portion accessible from the exterior portion of the body 101 (e.g., through a pouch when the stuffed toy 100 is configured as a kangaroo).

With continued reference to FIG. 4, the fastening structure 102 may be opened to expose the interior portion 110 of the stuffed toy 100. The interior portion 110 of the stuffed toy 100 may be sized and configured to provide the aforementioned chamber to accommodate at least one interchangeable scented packet 200 (FIG. 5) disposed therein. In some embodiments, the interior portion 110 of the stuffed toy 100 may be lined with, for example, a fabric liner so that the stuffing or filling within the stuffed toy 100 is not exposed within the interior portion 110. In some embodiments, a securing structure 104, such as a hook, may be disposed within the interior portion 110 for engaging and securing the at least one interchangeable scented packet 200 (FIG. 5) within the interior portion 110. Additional non-limiting examples of the securing structure 104 include complementary buttons and buttonholes, snaps and snap receptacles, or hook-and-loop fasteners, etc., which may be respectively formed on the interior portion 110 of the stuffed toy 100 and the at least one interchangeable scented packet 200 (FIG. 5) for securing the at least one interchangeable scented packet 200 within the interior portion 110. As another alternative securing structure 104, an elastic loop may be employed within the interior portion 110 and the at least one interchangeable scented packet 200 may be configured with two laterally extending portions separated by a narrow neck to be engaged by the elastic loop when in a relaxed position.

FIG. 5 illustrates an enlarged view of the at least one interchangeable scented packet 200. The at least one interchangeable scented packet 200 may comprise at least two pieces of material 206, 208 sealed around a perimeter 210 of the at least one interchangeable scented packet 200, or a single piece of material folded over itself and sealed around the perimeter 210 at adjacent edges. The material may comprise a woven or non-woven fabric. At least one of the two pieces of material 206, 208 of the at least one interchangeable scented packet 200 may comprise a mesh, netted, or other air-permeable material. One non-woven air-permeable material may comprise GORE-TEX® fabric, or another breathable polymer fabric. In some embodiments, the at least one of the two pieces of material 206, 208 may have an open surface area of at least about 30%. In additional embodiments, the at least one of the two pieces of material 206, 208 may have an open surface area of at least about 60%. In further embodiments, wherein a single piece of material is employed, the entire at least one interchangeable scented packet 200 exterior may exhibit the same permeability. A coupling structure 202 such as a loop may be attached to the at least one interchangeable scented packet 200, such as on a corner of the perimeter 210. The coupling structure 202 may be configured to be engaged by, and coupled to, the securing structure 104 (FIG. 4) (e.g., a hook) within the interior portion 110 of the stuffed toy 100 for securing the at least one interchangeable scented packet 200 within the interior portion 110. In additional embodiments, the coupling structure 202 may comprise a button or a snap receptacle on the at least one interchangeable scented packet 200 to be coupled to a corresponding buttonhole or snap within the interior portion 110 of the stuffed toy 100.

Within the at least one interchangeable scented packet 200 are confined a plurality of scented elements that may comprise a plurality of scented beads 204. The plurality of scented beads 204 may comprise a plastic or polymer material. In some embodiments, the plurality of scented beads 204 may comprise a polymer material having a fragrance coating applied thereto. In additional embodiments, the fragrance may be added to the polymer material during formation of the plurality of scented beads 204 such that the fragrance is dispersed throughout the polymer material of the plurality of scented beads 204. The fragrance may be either water-based or oil-based. The fragrance may contain a scented material such as an ester, a terpene, an aldehyde, a ketone, or any combination thereof. The fragrance may be any type of aroma, including, without limitation, scents of fruits, mint, herbs, and the like. Fragrances that are typically associated with aromatherapy, deodorizing, and other scents may also be used, as well as combinations of fragrances having different scents. In additional embodiments, scent releasing materials other than the plurality of scented beads 204 may be confined within the at least one interchangeable scented packet 200. For example, in some embodiments, a crushed leaf potpourri, or a fragrant body comprised of a scented material that will volatize over time and release its fragrance may be confined within the at least one interchangeable scented packet 200. The plurality of scented beads 204 or other scent releasing material may be loosely packed within the at least one interchangeable scented packet 200, or be of substantially flexible character, so as to not reduce the softness of the stuffed toy 100.

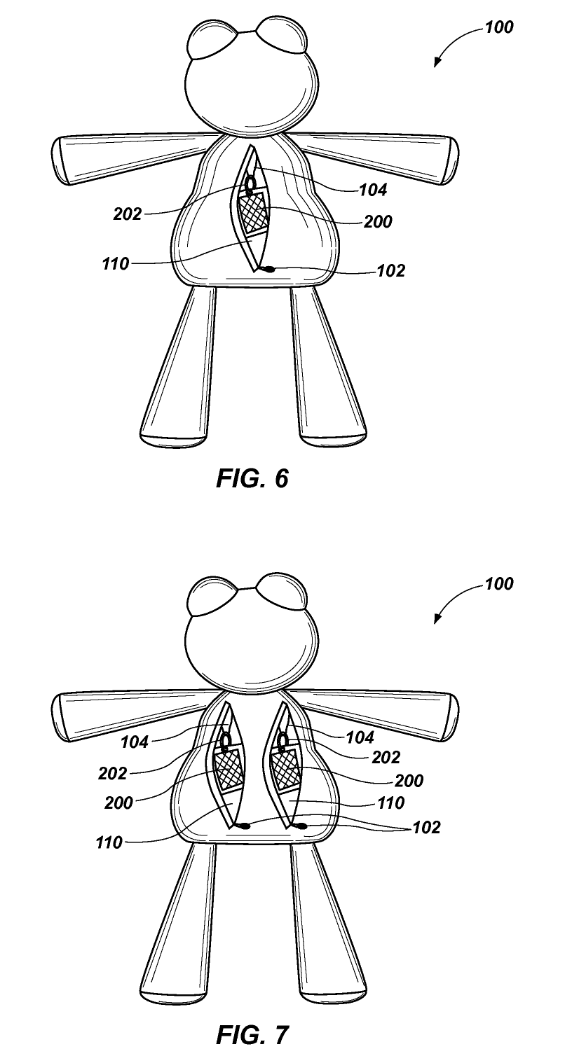

FIG. 6 illustrates the stuffed toy 100 having the at least one interchangeable scented packet 200 disposed within the interior portion 110 of the stuffed toy 100. As shown in FIG. 6, the coupling structure 202 on the at least one interchangeable scented packet 200 may be a loop to be looped over the securing structure 104, which may comprise a hook within the interior portion 110, to secure the at least one interchangeable scented packet 200 within the interior portion 110. The interior portion 110 may be configured to hold one interchangeable scented packet 200, or, optionally, in some embodiments, the interior portion 110 may be configured to hold more than one interchangeable scented packet 200.

When a user desires to change the at least one interchangeable scented packet 200, the user may open the fastening structure 102 (i.e., unzip the zipper, unbutton the buttons, detach complementary magnets, or unhook the hook-and-loop fasteners), undo the securing means (i.e., uncouple the coupling structure 202 from the securing structure 104), if present, and remove the at least one interchangeable scented packet 200 from the interior portion 110 of the stuffed toy 100. The user then may place another interchangeable scented packet 200 within the interior portion 110 of the stuffed toy 100, secure the securing structure 104 (i.e., couple the coupling structure 202 to the securing structure 104 within the interior portion 110 of the stuffed toy 100), if present, and fasten the fastening structures 102 (i.e., zip the zipper, attach complementary magnets, or hook the hook-and-loop fasteners).

Because the at least one interchangeable scented packet 200 is easily removable from the stuffed toy 100 by merely opening or unfastening the fastening structure 102, the user may select any desirable scent for the stuffed toy 100. In addition, as the strength of the fragrance emanating from the at least one interchangeable scented packet 200 wanes, the user may place a new scented packet 200 having the same or a different scent within the stuffed toy 100 to renew the scent emanating therefrom.

FIG. 7 illustrates a stuffed toy 100 configured to contain more than one interchangeable scented packet 200 in the interior portion 110 of the stuffed toy 100 to enable the user to create a desired combination of scents. The interior portion 110 of the stuffed toy 100 may be configured to hold more than one interchangeable scented packet 200. For example, interior portion 110 may comprise two adjacent chambers, each of which may comprise a securing structure 104 therein. More specifically, the interior portion 110 may comprise separate chambers, each of which may have a fastening structure 102 to close off the interior portion 110 of the stuffed toy 100. The user may place at least one interchangeable scented packet 200 in each of the adjacent chambers. In additional embodiments, the interior portion 110 may include only a single chamber in which two or more securing structures 104 are disposed. It is noted that a securing structure 104 for the interchangeable scented packets 200 may not be required if fastening structure 102 provides a sufficiently robust closure.

The stuffed toy 100 of the present disclosure may be used to provide a safe and convenient means of providing a desired scent to an area. Candles and other wax products require a flame or other heating element, such as an electrically powered heating element, to melt the wax. Potpourri and scented oils are typically placed in open containers and, thus, are often messy and may be of concern when small children and pets populate a household. However, because the plurality of scented beads 204 is confined within the at least one interchangeable scented packet 200, which is enclosed within the stuffed toy 100, the stuffed toy 100 does not present any of the issues associated with the use of candles, waxes, potpourri and oils. The stuffed toy 100 also may be used to provide an aesthetically pleasing means of providing a desired scent to an area while also concealing the source of the scent.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors.

What is claimed is:

1. A stuffed toy, comprising:
an interior portion within a body of the stuffed toy;
at least one interchangeable scented packet disposed within the interior portion; and
a fastening structure for providing selective access to the interior portion.

2. The stuffed toy of claim 1, wherein the interior portion comprises a plurality of adjacent chambers.

3. The stuffed toy of claim 2, wherein the at least one interchangeable scented packet comprises a plurality of interchangeable scented packets, each disposed within a chamber of the plurality of adjacent chambers.

4. The stuffed toy of claim 1, wherein the at least one interchangeable scented packet comprises a plurality of scented beads.

5. The stuffed toy of claim 1, wherein the at least one interchangeable scented packet comprises a porous material enclosing a scented material.

6. The stuffed toy of claim 1, wherein the fastening structure comprises at least one of a zipper, a hook-and-loop material, and a magnetic fastener.

7. The stuffed toy of claim 1, further comprising a securing structure for securing the at least one interchangeable scented packet within the interior portion.

8. The stuffed toy of claim 7, wherein the securing structure comprises:
a hook coupled to the body within the interior portion; and
a loop coupled to the at least one interchangeable scented packet and configured to engage the hook.

9. The stuffed toy of claim 7, wherein the securing structure comprises:
a buttonhole formed in the body within the interior portion; and
a button coupled to the at least one interchangeable scented packet and configured to couple with the buttonhole.

10. The stuffed toy of claim 7, wherein the securing structure comprises:
a snap coupled to the body within the interior portion; and
a snap receptacle coupled to the at least one interchangeable scented packet and configured to engage the snap.

11. A system for scenting an area, comprising:
a stuffed toy comprising an interior portion within a body of the stuffed toy; and
at least one interchangeable scented packet configured to be removably disposed within the interior portion.

12. The system of claim 11, wherein the stuffed toy further comprises a fastening structure for accessing the interior portion to remove the at least one interchangeable scented packet.

13. The system of claim 11, wherein the at least one interchangeable scented packet comprises a fragrance selected from the group consisting of a fruit fragrance, a mint fragrance, an herb fragrance, and any combination thereof.

14. The system of claim 11, wherein the at least one interchangeable scented packet comprises a fragrance consisting essentially of an ester, a ketone, an aldehyde, a terpene, and any combination thereof.

15. A method of forming a scented stuffed toy, comprising:
opening a fastening structure in a body of a stuffed toy to access an interior portion of the body of the stuffed toy;
disposing at least one interchangeable scented packet within the interior portion of the body of the stuffed toy; and
closing the fastening structure.

16. The method of claim 15, further comprising removing another interchangeable scented packet from the interior portion of the body of the stuffed toy prior to disposing the at least one interchangeable scented packet within the interior portion.

17. The method of claim 15, wherein opening a fastening structure in a body of a stuffed toy comprises at least one of:
unzipping a zipper in the body of the stuffed toy;
detaching complementary magnets of a magnetic fastener in the body of the stuffed toy; and
unhooking hook-and-loop fasteners in the body of the stuffed toy.

18. The method of claim 15, wherein closing the fastening structure comprises at least one of:
zipping a zipper in the body of the stuffed toy;
attaching complementary magnets of a magnetic fastener in the body of the stuffed toy; and
hooking hook-and-loop fasteners in the body of the stuffed toy.

19. The method of claim 15, wherein disposing the at least one interchangeable scented packet within the interior portion of the body of the stuffed toy comprises securing the at least one interchangeable scented packet within the interior portion of the body of the stuffed toy.

20. The method of claim 19, wherein securing the at least one interchangeable scented packet within the interior portion of the body of the stuffed toy comprises at least one of:
hooking a loop coupled to the at least one interchangeable scented packet to a hook coupled to the body of the stuffed toy within the interior portion of the stuffed toy;
buttoning a button coupled to the at least one interchangeable scented packet to a buttonhole formed in the body of the stuffed toy within the interior portion of the body of the stuffed toy; and
snapping a snap receptacle coupled to the at least one interchangeable scented packet to a snap coupled to the body of the stuffed toy within the interior portion of the stuffed toy.
